(19) United States
(12) Patent Application Publication
(10) Pub. No.: US 2009/0188374 A1
(43) Pub. Date: Jul. 30, 2009

(54) ELECTRONIC MUSICAL KEYBOARD WITH TACTILE FEEDBACK

(76) Inventor: John Bertil Folkesson, Stockholm (SE)

Correspondence Address: John Folkesson, Professorsslingan 33, Stockholm, SE-10405, SE

(21) Appl. No.: 12/355,762

(22) Filed: Jan. 17, 2009

Related U.S. Application Data
(60) Provisional application No. 61/024,281, filed on Jan. 29, 2008.
(60) Provisional application No. 61/027,489, filed on Feb. 11, 2008.

(51) Int. Cl. G10C 3/12

(52) U.S. Cl. 84/423 R

(57) ABSTRACT

Disclosed are systems and methods of receiving note selections from a musician while providing an appropriate tactile sensation to the musician's fingers.

### BACKGROUND OF THE INVENTION

This application claims the benefit of U.S. application Ser. No. 61/024,281 of JOHN FOLKESSON filed Jan. 29, 2008 for ELECTRONIC MUSICAL KEYBOARD WITH TACKTILE FEEDBACK, the contents of which are herein incorporated by reference. This application claims the benefit of U.S. application Ser. No. 61/027,489 of JOHN FOLKESSON filed Feb. 11, 2008 for ELECTRONIC MUSICAL KEYBOARD PERFORMANCE SYSTEM, the contents of which are herein incorporated by reference.

### FIELD OF THE INVENTION

This invention relates generally to systems and methods for generating music and, more particularly, to systems and methods of receiving note selections from a musician while providing an appropriate tactile sensation to the musician's fingers.

### DESCRIPTION OF RELATED ART

When a trained piano player is asked to play faster he will tend to lift his fingers higher and strike the keys more sharply. This is a bit surprising as it requires larger finger movement than simply pressing the keys down from a position near or touching the key top surface. This has been shown to be related to the need for greater tactile feedback at the instant of finger key contact. This feedback allows the player to achieve better timing precision when playing faster. At faster tempos the timing needs to be more precise to keep the error relative to the length of the beat about constant.

It seems that the musician needs to feel a force from the key surface at the instant of finger key contact above a certain threshold in order to properly control the timing of the performance. This is why musicians complain about some electronic keyboards as being ‘too light’ to play well on. They speak of having their playing become sloppy. The typical key mechanism of an electronic musical keyboard includes a key having a pivoted lever with a certain moment of inertia around the pivot point, a nearly constant gravitational force giving rise to a constant torque around the pivot point, and a spring which returns the key to the up position. The system has three parameters that can be chosen to try and optimize the key action. They are the spring constant, the inertia of the key, and the bias loading on the spring. The force of gravity also acts on the key but its effect is typically nearly equivalent to the bias force on the spring and does not add any additional control over the mechanism.

We can give four measures of the quality of the key action. The first measure, the key return time, is the time it takes the key to return to the up position when released from the down position. This cannot be too long or the key will feel sluggish and not allow fast playing.

The second measure is related to key stiffness. One technique that is possible on a well balanced acoustic piano but not light electronic keyboards is where the performer strikes the key sharply, not pressing the key all the way to bottom. The inertia of the key allows the performer to impart it with enough momentum to have it sound the note. This allows trills and tremolos played by a technique analogous to bouncing a basketball. In order to evaluate the effective inertia of the key as felt by the performer we can compare the minimum velocity that the performer must impart to the key by some angle near the top of key travel to have the key continue on its own momentum to key bottom. We can call this the ‘stiffness velocity’. Musicians complain about a ‘spongy feel’ when the stiffness velocity is too high.

The third measure has to do with tactile feedback. As we have said the force pressing against the finger at the instant of finger key contact is important for proper tactile feedback. We call this force the tactile force. Studies have shown that it must be sufficiently large to ensure good timing precision.

A final measure on the system is to hold the bouncing on key return to the up position low. We can call this the ‘bounce’.

These four measures each put constraints on a good action. For a simple spring lever key mechanism there are three parameters to adjust in order to achieve an optimal compromise. In general a larger spring constant will speed up the return time and improve the tactile force. It worsens the stiffness velocity. The increasing the bias has a similar effect on the tactile force, return time, and stiffness velocity. It also will improve the bounce significantly. It is the stiffness then that remains a problem. Increasing the inertia helps the stiffness and the tactile force while making the return time slower. Inertia is increased by adding weight to the key (and strengthening its supporting structure) making the keyboard heavier as well as adding to the cost.

There are currently many electronic keyboard instruments with a variety of key mechanisms. As we described in the previous section, one common type has a lightweight key that is pressed by the user and when released returned to the up position by a spring. These keyboards suffer from being ‘too light’. To help this situation the springs are sometimes loaded with a tension higher than needed to return them quickly to the up position. This tension then can produce the required force but then the keys have a undesirable stiffness all the way down. This stiffness makes rapid playing more difficult. It also makes certain playing techniques of acoustic pianos impossible.

An acoustic piano, in contrast, has a hammer that is thrown by the key mechanism at the strings. When the hammer flies away from the key linkage the force felt by the finger drops sharply due to the drop in the inertia. Besides this the force has by then already dropped considerable from its value on finger to key contact as the key and finger are now moving at the same velocity. Summarizing this, a light-weight key and spring can not reproduce the complicated dynamic force between the finger and key when the key is struck sharply. The finger feels a sharp force when it makes contact with the inertia of the piano key/hammer system. Then the finger velocity drops and the key begins to move causing the force to drop. When the hammer flies away the force drops even more. It is not the case that acoustic piano has the ideal key action but it is a standard that most keyboard players are comfortable with.

One way to improve the action of electronic keyboards is to add mass to the key to give them greater moment of inertia around the rotation axis. In principle the addition of mass to a spring loaded key can produce a good tactile feedback without making the keys too stiff. If the spring is properly loaded and dimensioned the return time and bounce will be adequate. One problem remaining is that the weight of the keyboard becomes difficult to transport and adds considerable to the cost of the keyboard. Musicians naturally prefer lighter weight equipment to carry and set up at gigs. The mass added to each key can be 150 g which when multiplied by 88 keys gives over 13 kg (29 lbs). This weight must be supported by a strong structure which often weighs as much as the keys. Overall the weight of the keyboard can be 18-32 kg (40-70 lbs). This is more weight than can be easily carried by an average person for more than a short distance.

There are a large number of patents for key mechanism with hammers. These all have multiple levers for each key and try to match a piano action. These can be very elaborate and are normally used on high end keyboards. These are both expensive and heavy. They can give an excellent action.

There have been a number of proposals to include an active feedback to each key. This would include an electro-mechanical actuator part to apply a time varying force to the key opposing the finger pressure. This force would be calculated in a digital filter that gets its input data from a sensor attached to the key and outputs a control signal to the actuator. The sensor could measure either position, velocity, acceleration or force. Such a system could produce virtually any touch response. The main problem being that it would be quite a lot more expensive than simply adding mass.

Other mechanisms that have helped are adding some viscosity in the form of a layer of grease between stationary parts and moving parts. By careful design of surfaces for this grease layer an improved damped key action can be achieved. This helps reduce the bounce for a weighted action keyboard without needing to load the springs but it is still not possible to achieve excellent action without also adding a substantial amount of mass.

There have been a number of patents that utilize a pair of permanent magnets, one on each key and one attached to the support under the key. These have the magnets repelling one another to create a change in the touch response of the key. As magnetic forces have the property of decreasing rapidly as the key is depressed, these forces will act mostly on the key bottom part of the travel, increasing rapidly in strength at the bottom of key travel.

One patent, JP 07-099475,B (1995), has proposed using the force of eddy currents produced by moving a magnet relative to a conductor. This would give a velocity dependent damping force.

In U.S. Pat. No. 5,129,301 a mechanism is presented that uses only magnets attracting metal plates on the keys. This had the stated objective of eliminating the springs from the mechanism as they were seen as undesirable due to the loss of resiliency over time. This invention relied on having a set of long magnets run the length of the keyboard over the back section of the keys. This was a mechanism for an organ.

There is at the time of this application a pending application, US patent application 20060070515, for a keyboard apparatus that has a passive key action where the goal is to produce a force that decreases with key travel. This is accomplished by a variety of mechanical means that utilize the elastic force of materials.

Other patents that pertain to keyboard feel adjust the key scaling along the keyboard from the low notes to the high. These try to simulate an acoustic piano in that the hammers become heavier for the lower notes. These describe a number of mechanisms for adjusting key return force but the goal is again different.

### SUMMARY OF THE INVENTION

According to an aspect of the present invention, there is a musical keyboard having a plurality of assemblies, each assembly generating an electrical signal assigned to a respective note of a musical scale. Each assembly comprises a moving part having a proximal end and a distal end, the distal end defining an activation surface exposed to the fingers of a player; a magnet biasing the activation surface toward an up position; and a spring biasing the activation surface toward the up position, wherein the upward force of the spring is greater than the upward force of the magnet when the activation surface is in the down position.

According to another aspect of the present invention, there is a method of operating a musical keyboard having a plurality of keys, each key configured to generate an electrical signal assigned to a respective note of a musical scale, each key having an activation surface exposed to the fingers of a player. The method comprises the steps, performed for each key, of biasing the activation surface toward an up position using a magnet; biasing the activation surface toward the up position, using a spring; and moving the activation surface toward a down position, at which point the return force of the magnet has substantially decreased and is less than the return force of the spring.

### BRIEF DESCRIPTION OF THE DRAWINGS

References are made to the following text taken in connection with the accompanying drawings, in which:

FIG. 1 shows a keyboard in accordance with an embodiment of the invention.

FIG. 2 shows a key of the keyboard of FIG. 1 in more detail.

FIG. 3 shows a part of the key of FIG. 2 in more detail.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

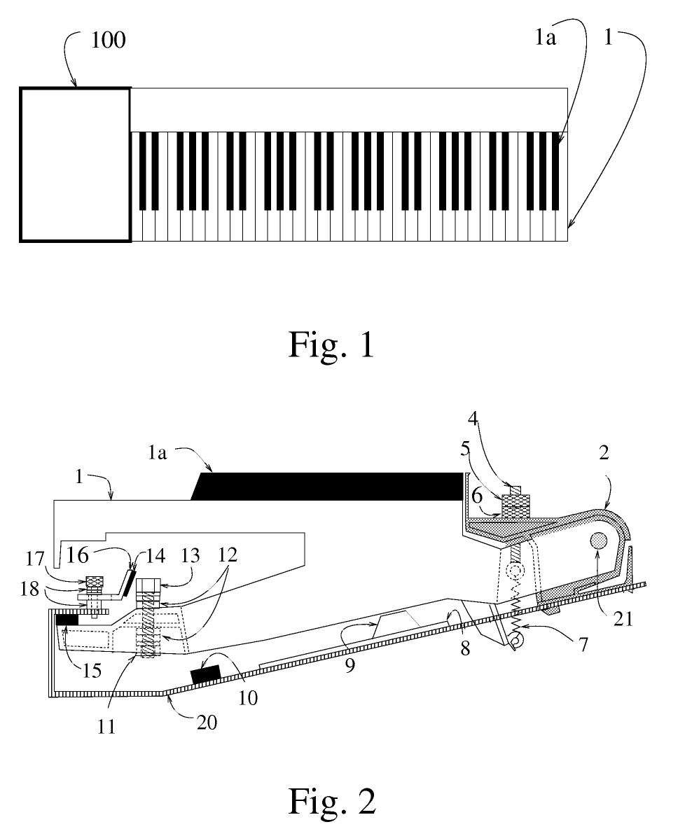

FIG. 1 a keyboard 100 having multiple white keys 1 and multiple black keys 1a in accordance with an exemplary embodiment of the present invention. The upper surfaces of the keys are laid out as on a standard piano keyboard while the lower key sections are uniformly laid out with 13.7 mm spacing along the length of the keyboard. These can be made of ABS plastic by injection molding.

FIG. 2 shows one of the keys 1 shown in FIG. 1. A magnet (14) is mounted on the key support (20) such that magnet (14) is near the bolt (13) when the key (1) is in the up position. As the key (1) is pressed the bolt (13) will move away from the magnet (14) and the attractive force will decrease quickly. By making the relative angle and position of the magnet (14) variable by the user, one can provide an adjustment to the strength and rate of decrease of the magnetic force. The adjustment mechanism includes a mounting plate (16) and a thumb screw (17) holding the magnet (14) in a fixed relation to the bolt (13). By loosening the thumb screw (17) the plate (16) can be moved, thereby adjusting the force.

The bolt (13) could also be moved by for example adding washers (18). This embodiment includes both a user adjustable extension spring and an user adjustable magnetic attractive force.

The pivot (21) is part of the plastic pivot support (2). The pivot support is fixed to the sheet metal key support member (20). This pivot support then gives support to the spring adjustment screw (4). This gives a bias tension to spring (7) that is user adjustable by turning the two thumb nuts (5) and (6). By tightening nuts (5) and (6) against one another, the bias is resistant to slipping as a result of the vibrations acting to loosen nuts (5) and (6). The spring (7) passes through the center of a hollow section of the key (1) and fastens to the key (1) via an arm that extends under the key support (20) by passing through a hole in that support.

The key (1) can produce a key velocity signal by membrane switch (9) attached to printed circuit board (8). The membrane switch (9) has a rubber boot with two conducting members that close two separate circuits. One conducting member closes before the other and the timing difference gives a measure of the velocity of the key press.

The rubber pad (10) will absorb some of the energy of the key motion and stop that motion at key bottom. This is paired with pad (15) that stops the key (1) in the up position. Pads (10) and (15) thus set the extent of travel for the key.

A key attractive member here in the form of the head of a steel hex head bolt (13) is attached directly to the key (1) with nut (11). The bolt also adds mass to the key and is positioned near the optimal point for adding moment of inertia around the pivot (21). For that reason it is provided with more washers (12) then needed for simply good attachment. These will provide a bit more inertia. The mass of bolt and its attachments will be less than 15 g which is far less than a typical mass added to a weighted key. This is consistent with the compromise we are after.

The permanent magnet (14) is attached to a steel plate (16). This is fixed at a particular angle and distance by thumb screw (17) and washers (18).

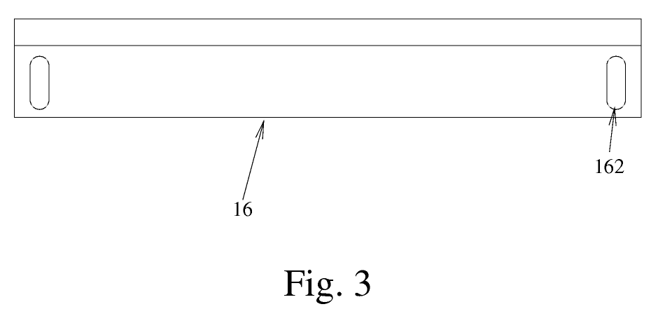

FIG. 3 shows to a slot (162) in plate (16). Screw (17) passes through slot (162) and a threaded hole in the horizontal portion of the key support. Thus, loosening the thumb screw one can slide the plate (16) closer or further from the bolt head (13).

The height of the magnet (14) relative to the bolt head can be changed by rearranging the washers (18) and (12). Thus, the user can then find a setting that is comfortable for him or her.

In an alternate embodiment, it would be possible to add an adjustment to the angle of the magnet.

Other embodiments can be formed by changing parts of the main embodiment. So one can have embodiments where the adjustable spring and/or magnet mounts are replaced by fixed mounts. It is also possible to replace the extension spring by an adjustable or fixed compression spring attached to the key support under the keys and pressing up on the keys from about the same position as the extension spring in the figure. This would have a mounting part under the key support with the spring passing thru a hole in the support as in the figure. The compression spring would then press down on the mounting part and up on the key. The mounting part could then have a screw to adjust its height relative to the key. Another variation is to replace the steel bolt key attractive member by a properly oriented magnet.

One can replace one or both of the user adjustable parts by fixed, non-adjustable parts. So if parts 4, 5, and 6 are simply replaced by attaching the spring 7 directly to the pivot support 2 then we have realized an embodiment where the spring is non-adjustable. If on the other hand parts 16, 17 and 18 are replaced by extending the key support upwards and attaching the magnet 14 to it directly then an embodiment where the magnetic force is fixed is realized. If both of these replacements are made then another embodiment is realized.

In summary, an exemplary keyboard includes a plurality of keys (1) and (1a) attached to a key support (20) in such a way as to allow a limited rotation about an axis (21) when operated by the user and thus allowing the front of each key, closest to the user, to move between an up and down position. A plurality of springs (7) are each associated with a key such that each spring (7) applies a force between its key and the key support member (20) to return the key to the up position after being released. A plurality of bolts (13), configured to function as attractive key members, attached to each key, and have the property of being magnetically attracted to a pole of a respective permanent magnet (14).

There are permanent magnets (14) attached to the key support member (20), to provide an attractive force helping to hold the keys in the up position and such that this force decreases in strength along at least some portion of the downward travel of each key.

The springs (7) could be selected from a group consisting of compression springs and extension springs.

Nuts (5) and (6) act as a user adjustment mechanism for the bias loadings on the springs.

Thumb screw (17) and washer (18) enable user adjustability of the magnetic attractive forces by changing at least one parameter of the magnetic system selected from the group of relative position and orientation between the permanent magnet (14) and bolt (13).

Thus, the system includes a plurality of permanent magnets (14), each under a respective key, each attached to the key support member (20), each acting on a respective bolt (13) in such a way as to provide an attractive force helping to hold the keys in the up position and such that this force decreases in strength along at least some portion of the downward travel of each key.

Spring adjustment screw (4) and nuts (5) and (6) constitute an adjustment mechanism for the bias loadings on the springs (7), allowing a user to customize the static key force.

The magnets are attached to the keyboard key support member and give rise to an attractive force holding the key in the up position. This attractive force is of relatively short range, to give tactile feedback to the user on finger to key contact at the beginning of the key stroke. The spring is used to give a return force that is felt over most of the travel of the key. The spring then is the main return mechanism. By separating the functions of tactile feedback from key return, the key return force can be substantially reduced.

The static force needed to depress a key is about 50-60 grams for a typical grand piano action. This is measured at the end of the key closest to the performer. The force felt by the performer when striking the key is this plus the force of inertia of the key. This inertial force depends on the velocity of the finger and can be several hundred grams. An electronic keyboard that relies on added weight to provide the tactile force might have as much as 150 g of weight added. This inertia then requires a strong spring to return it quickly to the up position. With the exemplary keyboard, the inertial is approximately ⅙ that of a fully weighted key and thus the spring can be about ⅙ as strong, approximately 20 grams plus the amount needed to offset the static gravitation force which gives a static spring force of about 45 grams or 20 grams net of gravitation. The magnet provides some of the missing tactile force during the initial depression of the key. The magnet force is user variable from about 10-400 grams, 250 grams being a typical value. This is the force at the top of the travel. It will decrease exponentially with about a 1-2 mm half distance over the 10 mm of key travel. This then gives a variable force felt by the finger during an ‘average’ stroke that is similar to that of a piano action.

The force at the end of the key travel will be much less than either the light or weighted key action. This is more like a well balanced grand piano, which has the force drop nearly to zero at the end. The key is then less stiff. Such a force can be generated by a Neodymium magnet, for example. The half distance can be altered by holding the magnet at an angle to the key travel direction, so the figure shows 0 degree angle, at 60 degrees the half-distance is doubled approximately.

Thus, the exemplary system produces tactile feedback at the start of finger key contact and has this drop to a small force at key bottom.

The exemplary system provides a response that allows good timing precision through the use of tactile feedback on finger key contact.

The exemplary system enhances the response of the key action with regard to stiffness and tactile response without introducing a large mass to the key.

In the exemplary system, the function of static tactile feedback is separate from the function of key return. The magnetic force, affecting the function of tactile feedback, is short range acting mainly at the instant of finger to key contact. This is done at a point as far from the pivot of the key as is practical to increase the torque for a given magnetic force. The force will act to help hold the key in the up position and will drop to a negligible value before the key reaches the fully down position. The magnetically attractive member could be a ferromagnetic material with no permanent magnetization. This force will act with a decreasing force as the key is pressed down. When this force is combined with a spring a satisfactory return speed can be obtained.

Thus, the exemplary keyboard is light weight and can be played on by a skilled pianist with precision comparable to that which could be achieved with a good quality acoustic piano.

The magnet does not substantially affect perceived stiffness as the torque drops so quickly. The tactile force on contact however will increase. The return time will improve slightly as will the bounce.

The keyboards would be produced with a factory setting identical for each key that gives a reasonably good tactile feedback without too much non-linearity in the force. The user would be able to then adjust this compromise to match his or her ability to compensate the non-linearity. As the performer becomes more used to the keyboard he or she should be able to increase the tactile feedback giving improved timing precision.

The return spring can take on a variety of forms. One is to have a coil extension spring mounted on the key support and pulling up on the key. Another is to have a compression spring pushing up on the key. These can have a screw mechanism that adjusts the bias on the spring by changes the distance that extension spring is stretched or the amount the compression spring is compressed when the key is in the up position.

The attachment point to the key support can be adjusted.

The structure of the lower section of black keys (1a) is the same as that of white keys (1) described above.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. A keyboard assembly for an electronic musical instrument comprising:
a key support member;
a plurality of keys attached to the key support member in such a way as to allow a limited rotation about an axis when operated by the user and thus allowing the distal end of each key relative to the axis to move between an up and down position;
a plurality of springs each with an associated key such that each spring applies a force between its key and the key support member to return the key to the up position after being released;
a plurality of attractive key members attached to each key having the property of being magnetically attracted to a pole of a permanent magnet; and
a system of a number of permanent magnets attached to the key support member and that act on the attractive key members in such a way as to provide an attractive force helping to hold the keys in the up position and such that this force decreases in strength along at least some portion of the downward travel of each key.

2. A keyboard assembly according to claim 1 wherein the magnetic attractive forces are user adjustable via mechanisms, that change at least one parameter of the magnetic system selected from the group of relative positions and orientations between the permanent magnets and attractive members.

3. A keyboard assembly according to claim 1 also comprising a plurality of user adjustment mechanisms for the bias loadings on the springs which allows a user to customize the static key force.

4. A keyboard assembly according to claim 2 also comprising a plurality of user adjustment mechanisms for the bias loadings on the springs which allows a user to customize the static key force.

5. A keyboard assembly according to claim 1 wherein the springs are selected from a group consisting of compression springs and extension springs.

6. A keyboard assembly according to claim 2 wherein the springs are selected from a group consisting of compression springs and extension springs.

7. A keyboard assembly according to claim 3 wherein the springs are selected from a group consisting of compression springs and extension springs.

8. A keyboard assembly according to claim 4 wherein the springs are selected from a group consisting of compression springs and extension springs.

9. The keyboard assembly of claim 1 wherein a distance between the magnet and the distal end is less than a distance between the magnet and the proximal end.

10. The keyboard assembly of claim 1 wherein a distance between the spring and the proximal end is less than a distance between the spring and the distal end.

11. The keyboard assembly of claim 1 wherein the magnet is under the key.

12. The keyboard assembly of claim 1 wherein a strength and position of the magnet are such that an upward force on the distal end is in the range 10-400 grams, when the key is in the up position.

13. A method of operating a musical keyboard having a plurality of keys, each key configured to generate an electrical signal assigned to a respective note of a musical scale, each key having an activation surface exposed to the fingers of a player, the method comprising the steps, performed for each key, of:
biasing the activation surface toward an up position using a magnet;
biasing the activation surface toward the up position, using a spring located between the magnet and the proximal end; and
moving the activation surface toward a down position, to cause the biasing force of the spring to be greater than a biasing force of the magnet.
